(19) United States
(12) Patent Application Publication
(10) Pub. No.: US 2010/0050221 A1
(43) Pub. Date: Feb. 25, 2010

(54) Image Delivery System with Image Quality Varying with Frame Rate

(76) Inventors: David J. McCutchen, Portland, OR (US); Myles McGovern, Vernon (CA); Dustin Moore, Estacada, OR (US); Adam Herr, Forest Grove, OR (US)

Correspondence Address: MARGER JOHNSON & MCCOLLOM, P.C., 210 SW MORRISON STREET, SUITE 400, PORTLAND, OR, 97204, US

(21) Appl. No.: 12/414,569

(22) Filed: Mar. 30, 2009

Related U.S. Application Data
(60) Provisional application No. 61/074,145, filed on Jun. 20, 2008.

(51) Int. Cl. H04N 7/173; H04N 7/12; H04N 7/00

(52) U.S. Cl. 725/109; 375/240.01; 348/36; 348/E07.001; 375/E07.076

(57) ABSTRACT

An image delivery system responds to limits of bandwidth by changing the resolution of the delivered image according to the frame rate required. For a motion picture image, the resolution is reduced in order to maintain the frame rate, and if the image is paused, a maximum image resolution is loaded instead during the time the image is not being updated. For immersive imaging systems, there is a similar adjustment of resolution according to frame rate and the bandwidth requirements, and the user is free to look around, either inside a motion picture at reduced resolution or a paused image at a higher resolution. This higher resolution is typically seen in a movable region of interest window extracted from the larger immersive image.

### APPLICATION HISTORY

This application claims priority from provisional application Ser. No. 61/074,145 filed Jun. 20, 2008.

### FIELD OF THE INVENTION

This invention generally relates to a delivery system for motion picture images according to responses from a user, and to a panoramic image reproduction system.

### BACKGROUND AND SUMMARY OF THE INVENTION

Typically motion picture images are played back in a continuous stream for a viewer. If this stream is paused, the viewer gets to see one frame in the same resolution. This has been true both in older motion picture systems and in newer ones based on digital recording.

The displayed resolution reflects how the stream is recorded. An 8 mm film has a lower resolution than a 35 mm film, and digital streams can be made in a variety of sizes. The resolution of any one frame of the motion picture stream can be called the frame resolution. For example, a video stream in the CCIR-601 standard can be characterized as 720×480 pixel frame resolution, 30 frames per second. All of the frames in the stream have the same resolution. The rapid updating of the frames tends to enhance the impression of resolution in the viewer, so that the apparent motion resolution of the stream is higher than the frame resolution of one image. This can be seen when one pauses video, where typically the still frame has less apparent resolution than the motion stream. Video manufacturers try to disguise this effect by processing the paused frame, adding scan line interpolation and other enhancements, but the basic frame resolution supplied by the playback stream is still unchanged, whether it is updating as a motion stream or paused as a still frame.

Still image photography typically has a much higher frame resolution, but at the expense of the illusion of motion. The capacity of the recording system and the electronics involved also imposes limits on how many pixels can be recorded, and at what frame rate. Given a fixed capacity imposed by the recording device, then the higher the resolution of a frame, the slower the frame rate. For example, U.S. Pat. No. 5,440,343 “Motion/Still Electronic Image Sensing Apparatus” by Parulski, et. al. adjusts the frame rate of the recording device to a slower frame rate to allow for higher resolution. This, however, does not address the question of changing the resolution on demand for delivery; the recorded resolution is assumed to be what is finally displayed.

The delivery of digital image streams has typically been constrained by the bandwidth available. Whether wired or wireless, through a local network or over the Internet, every hardware standard and digital transmission protocol has a bandwidth limit. Typically, the wider the range of transmission to be done, the less the available bandwidth. For example, computer playback of a digital video file can be done successfully from a local hard drive even if 10 megabytes per second (which can also be called 80 megabits per second) is required. If the file is to be streamed over the Internet to a wireless device such as a Personal Digital Assistant (PDA) using a wireless streaming protocol such as EV-DO, the effective bandwidth can be closer to 50 Kilobytes (400 kilobits) per second. That means the second file has to be played back reliably in one half of one percent of the bandwidth of the first file.

The bandwidth management of streaming media has involved many different approaches. Often a stream is digitally compressed to match the available bandwidth. Different compression protocols can be used to balance size, quality, and expected use. Often several versions of a file are made available, and even exchanged to respond to messages that more or less bandwidth is available for transmission. For example, Netflix, a distributor of movies and other digital content, recently announced its Watch Now service, which streams a digitized movie for a subscriber to watch on a Windows PC, changing the resolution and quality according to the bandwidth available. However, the goal is still the delivery of a consistent frame speed as well as a consistent resolution.

To remove the constraints of real-time delivery, a buffer is usually included on the client side to allow a certain amount of the stream to be stored first before the playback begins. This is the most common method for streaming video clips over the Web, currently used by the popular video site YouTube, and most other streaming video outlets. In this way, a reserve of images is available if the delivery channel is slowed down, preventing an interruption in the flow of frames. However, with current methods, the frames filling the buffer have had the same frame resolution as the overall motion stream.

One attempt to specify more than one resolution for a motion stream is described by U.S. Pat. No. 5,691,767 “Video Conferencing System with High Resolution Still Image Capability” by Katsumi Tahara, where four frames of video are combined to make a higher resolution still image and transmitted according to the H.261 standard. This does not address the question of making a higher resolution recording initially and adjusting the resolution downward as necessary; the invention is directed toward giving the impression of higher resolution by reprocessing multiple frames. This approach would produce unsatisfactory results in many cases. If there is no motion in the scene, the multiple frames would produce the same results, even if combined, as a single image, since there is no significant difference between the pixels. If there is a lot of motion between the frames, the decision on how reconstruct a composite image involves enormous computational complexity, and tends to produce an image with motion blur.

A new field of possibilities is opened up by the advent of video panoramic imaging. In this approach, a closeup region of interest (ROI) is usually examined within a larger panoramic frame that remains unseen. This approach can be seen in immersive still photography, and more recently, in immersive video imaging. Immersive photography captures a more spherical field of view than panoramic photography, which is typically concerned with wide strips of image along a horizon. However, since both involve unusually wide fields of view, here the terms will be used together, with panoramic representing the general field, and immersive the more spherical embodiments.

Such panoramic imaging systems, and related applications, are known in the art, as illustrated by the applicant's articles “A Dodecahedral Approach to Immersive Imaging and Display,” ACM SIGGRAPH Computer Graphics, Vol. 31, No. 2, pp. 35-37, May 1997; “MPEG 3DAV—Video-Based Rendering for Interactive TV Applications, “Proc. of 10th Dortmunder Fernsehseminar, Dortmund, Germany, September 2003; and “3DAV Exploration of Video-Based Rendering Technology in MPEG,” IEEE Trans. Circuits and Systems for Video Technology, March 2004, Vol. 14, No. 3, pp. 348-356, and by the applicant's prior patent publications U.S. Pat. Nos. 5,023,725, 5,703,604, 6,141,034, and 6,317,166. Such systems and applications are also discussed in patents and patent publications to third parties, including U.S. Pat. Nos. 6,320,584, 6,323,858, 6,337,683, 6,690,374, 6,731,305, 6,738,073, 20020021353, 20020089587, 20030197785, 20040075738, and 20040257384.

Commercial systems for stitching images together to yield composite panoramas are marketed by various parties, including the ImmersiViewer and WorldView digital signal processing cards and the Immersive Media Postproduction Suite PC Software (offered by Immersive Media Company, the present assignee) used for making immersive video, and the QuickTime VR Authoring Studio (offered by Apple Computer Inc.), used for making immersive stills. In the discussion that follows, terms such as “immersive camera system” and “Telemmersion” are used to refer to such arrangements. No particular limitation should be inferred from these terms; they are used as general descriptors.

Recently immersive streaming video has been introduced by Immersive Media Company (IMC). A panoramic video stream is delivered, and each user is free to look around within it by making use of a simple IMC control on the client side. One option for delivery includes the delivery of files which are stored for later playback, and requires a further download of an IMC ActiveX control for looking around within the file and communicating with the web server. However, this requires the download of an ActiveX component which may be regarded by security programs as suspicious. Another option that is preferred uses the Shockwave/Flash protocol from Adobe to encode and stream the movie. This has the advantage of being more universally compatible with current browsers without requiring any extra downloads. The Shockwave/Flash movie streams can be viewed in a movable ROI after a short wait after the buffering is completed. One is then free to look around within the immersive movie, either while it is in motion, or while it is paused. This freedom to move around within a paused immersive still frame is a special characteristic of immersive movies.

Streaming the full panorama to everyone who requests it allows every viewer to choose their own ROI. However, the nature of looking only at a ROI means that only a small part of the overall panorama is being shown, in contrast to regular streaming video, where all of the streamed image is shown. Because of this, given a constraint on bandwidth, panoramic video has a disadvantage in displayed resolution. For example, a 640 pixel by 480 pixel video image can be streamed and seen at this full resolution, because every pixel is fully displayed. In contrast, an immersive panoramic image may be 1200×600, which is more than twice the resolution, and demands more than twice the bandwidth for streaming. But the displayed region of interest within this panorama may only end up being 340×280 pixels, so twice the bandwidth is needed for half the displayed resolution.

The present invention will address all of these shortcomings in the prior art.

### OBJECTS AND ADVANTAGES OF THE INVENTION

A. It is an object of the present invention to provide a method, and an apparatus for applying that method, for delivery of a high-resolution motion stream constrained to a variable resolution determined by the frame speed and the available bandwidth. Unlike the prior art, which is directed toward consistent delivery of a given image resolution and frame rate, the present invention will change the resolution according to the frame rate, in order to maximize the use of the available bandwidth and provide a more realistic viewer experience.

B. It is also an object of the present invention to provide a method, and an apparatus for applying that method, for increasing the resolution of a still frame when a motion video stream is paused, by substituting a higher resolution version of the paused frame for the motion version of the frame, again maximizing the use of the available bandwidth.

C. It is also an object of the present invention to provide a method, and an apparatus for applying that method, for increasing the apparent resolution of regions of interest within panoramic frames, by delivering higher resolution still panoramic frames or panoramic frames at slower frame rates, allowing the user to look around within a higher resolution image while using all of the available bandwidth.

### BRIEF DESCRIPTION OF THE DRAWINGS

FIG. 1 shows a schematic view of a high resolution motion picture recording, and options for its delivery at different resolutions according to the prior art.

FIG. 2 shows a schematic view of a high resolution motion picture recording, and its delivery according to the present invention.

FIG. 3 shows a schematic view of an immersive image frame and a region of interest within it, and a higher resolution version of the same frame with the same region of interest.

FIG. 4 shows a flow chart of the client and server components and the communications between them.

### DETAILED DESCRIPTION

In the discussion that follows, terms such as “panoramic”, “camera”, “streaming”, and “Internet” are used to describe the function and operation of the present invention and an exemplary type of distribution that could make use of the invention. No particular limitation should be inferred from these terms; they are used as general descriptors for image generation and delivery.

The present invention is directed toward an interactive delivery system that varies the resolution of a streaming or still image according to the available bandwidth and the commands of the user regarding frame speed. This has the effect of making the clearest possible image within a given bandwidth used for distribution. This principle applies for both motion pictures and stills, and for fully-displayed motion picture frames, and those which are partially displayed by looking at a region of interest, such as panoramic video frames.

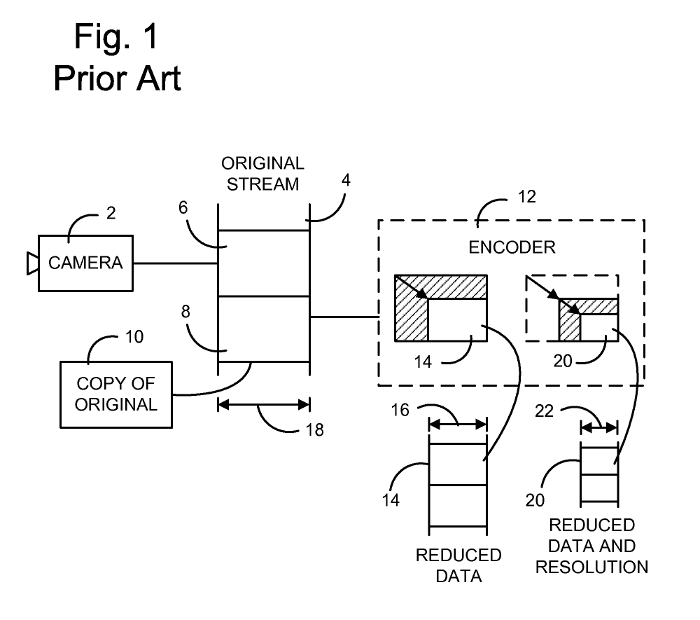

FIG. 1 shows a schematic view of a high resolution motion picture recording, and options for its delivery at different resolutions according to the prior art. A high resolution motion picture recording made by a camera system 2 is shown as a motion picture stream 4 which is made up of a series of frames such as 6 and 8. Typically this recording is either copied to make frames such as 10, or fed into an encoder 12. This encoder can reduce the data required for the image but not its resolution, to make an image such as at 14. These images can be made into a stream whose bandwidth 16 is less than the original recording bandwidth 18. The encoder can also reduce the resolution as well as the data size, to make a more reduced image 20 which can then be part of a stream whose bandwidth 22 is even smaller.

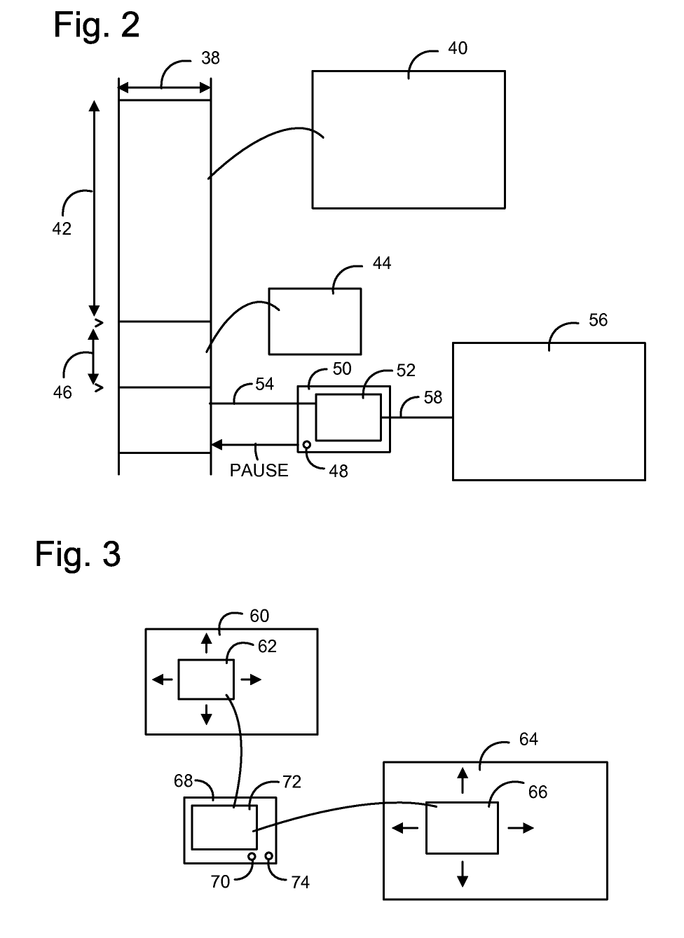

FIG. 2 shows a schematic view of a high resolution motion picture recording, and its delivery according to the present invention. A given bandwidth for delivery is shown by the width of a bandwidth stream 38. Therefore, the amount of data in an image frame 40, as shown by the image area, is shown as occupying a certain amount of the stream over a time scale 42. Another version of the same recording at a lower resolution, as shown by a smaller image 44, occupies less of the bandwidth stream's capacity and therefore can be transmitted in a shorter time 46. Multiple smaller images therefore can be updated rapidly and form motion pictures. If a pause command 48 from a user is received, according to user interaction with a viewing application 50 on a processor that includes an image display 52, then in exchange for the usual copy of the image 54, another copy 56 at a higher resolution can be substituted 58 in the bandwidth stream for delivery to the viewing application, due to the longer time allowed for the download by the suspension of the frame update requirement. Usually the lower resolution image is loaded first, and then the higher resolution version is substituted when it is finished loading, so there is no interruption in the display.

FIG. 3 shows an immersive image frame 60 and a region of interest 62 within it, and a higher resolution version 64 of the same frame with the same relative region of interest 66. The application 68 controlling the region of interest being displayed to the user typically contains controls 70 for the direction and field of view of the extracted window to be displayed 72, so the high resolution and low-resolution versions of a scene can have co-located regions of interest within the larger immersive recorded image. So what the user will see is that an image, or a region of interest within it, will apparently pop into a higher resolution when a pause command 74 is given by a user using the application.

A similar variation of resolution according to the time of update required can be used to deliver an intermediate resolution for a slow-motion image, either playing backward or forward, if it is requested by the user, by substituting a copy of the source image at a higher intermediate resolution to fill the available bandwidth at the slower frame update rate. This same principle can be applied to deliver a range of resolutions dynamically, based on the declared frame update speed within a given bandwidth.

The adjustment of image resolution reflects a variation in the action of an image server, as viewed through an image client. Typically the server and client are applications on a computing platform, such as a computer or mobile computing device. The communications protocol can be any appropriate protocol for the delivery of content on a network.

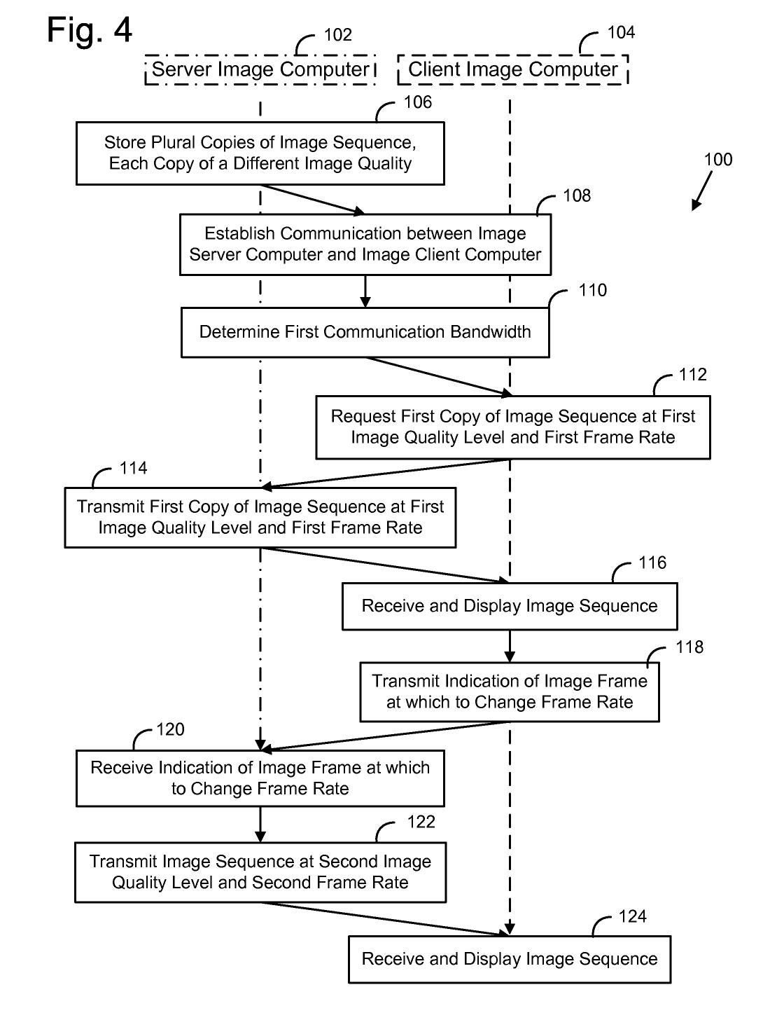

FIG. 4 shows the flow chart of a method 100 of delivering and displaying images from a motion picture sequence at varying levels of image quality. Steps of method 100 may be implemented by computer software stored in computer readable media of, and run on, a server image computer 102 and a client image computer 104, respectively.

The image server computer 102 has a memory (not shown) in which are stored plural copies of a sequence of images, each at a different level of image quality, representing the frames of a motion picture sequence. After establishing communication with an image client computer 104 containing an image client software application, and determining a bandwidth available for transmission to image client computer 104, image server computer 102 then receives a request from the image client computer 104, initiated by user interaction with the client software application, to transmit a sequence of images representing the frames of a motion picture sequence at a given frame rate and level of image quality. This transmission continues until the user initiates a further request through the client software application to change the frame rate at a given frame number in the sequence such as, for example, to pause the motion picture sequence. At this point, the transmission is changed from a first level of image quality to a second level of image quality, with the choice of what new level of image quality to use being determined by the available bandwidth and the new requested frame rate.

Step 106 indicates storing in a memory of image server computer 102 plural copies of a sequence of images, each copy having a different level of image quality and representing plural frames of a motion picture sequence.

Step 108 indicates establishing communication over a computer network with an image client computer. For example, the computer network may include the Internet.

Step 110 indicates determining a first communication bandwidth available for transmission of the motion picture sequence from image server computer 102 to the image client computer 104.

Step 112 indicates requesting a first copy of the sequence of images representing the frames of the motion picture sequence at a first frame rate and at a first level of image quality according to the first communication bandwidth. The image quality image quality corresponding to or representing one or more of image resolution, an amount of data compression used in storing the sequence of images, and a choice of codec for playing of displaying the sequence of images.

Step 114 indicates transmitting from server image computer 102 to client image computer 104 a first copy of the sequence of images representing the frames of the motion picture sequence at a first frame rate and at a first level of image quality according to the first communication bandwidth.

Step 116 indicates receiving and displaying at image client computer 104 the sequence of images from the motion picture sequence from image server computer 102 at the first frame rate and the first level of image quality, according to the first communication bandwidth.

Step 118 indicates transmitting from client image computer 104 to server image computer 102 an indication of a frame in the motion picture sequence at which there is a specified change to a second frame rate.

Step 120 receiving at image server computer 104 an indication from image client computer 102 of a specific frame of the motion picture sequence at which there is a specified change to a second frame rate.

Step 122 indicates changing transmission of the motion picture sequence from image server computer 102 from the first level of image quality and first frame rate to a second level of image quality at the second frame rate.

Step 124 indicates receiving and displaying at image client computer 104 the sequence of images from the motion picture sequence from image server computer 102 at the second frame rate and the second level of image quality, according to the first communication bandwidth.

As an example, delivery can be done through an internet browser interface. As demonstrated in June 2007 by the Immersive Media Company, a browser opens a player window showing using a region of interest representing a movable window within the immersive image. As the image plays forward, the default frame speed is as high as possible, for the smoothest possible motion. If the bandwidth is too narrow to display the full motion, full resolution version of the immersive movie on the server, then the update requests for the frames of the movie to be delivered will be irregular or delayed beyond their expected times. If this happens, a version of the movie that is more compressed or downscaled in resolution will be substituted instead, to better fit into the available bandwidth. Once this bandwidth to the client is known, then it is easier to predict what available variations of resolution should be substituted in response to requests from the client for changes of frame rate.

The media of different resolutions can be movies with different resolutions, or compression settings, or codec types. For instance, MotionJPEG movies have frames that are large in size, but are relatively uncompressed, and the simple frame structure offers advantages in designing frame navigation features such as slow motion back and forth. The JPEG compression of the individual frames inherent in Motion JPEG compression lends itself to the extraction and display of fixed levels of image resolution decimation within each frame, by making use of fewer than the usual number of DCT coefficients. Wavelet compression also has an inherent pyramid of resolutions inherent in the compression process, and a lower or higher resolution results from the number of steps in the pyramid that are delivered. The selection of the resolution should preferably be done by the image server, to avoid unnecessary transmission bandwidth.

Other codecs such as Flash offer more compression so take up less bandwidth, but may require more resources for the initial compression and decompression, and may be limited in frame size or color performance. For still images, JPEG, DNG, BMP and other image types have the largest data sizes, but offer the best resolution, color fidelity and dynamic range.

In this example, in order to substitute a high resolution JPEG still for a frame of a movie, the player and the server can communicate through a web browser player control. The Shockwave Viewer uses high-resolution stills when the player is in a paused state. This is accomplished by using a web service that allows the download of stills based on the current frame of a video. The JPEG repository used by the web service is generated in conjunction with the video encoding process. The timestamp on each still frame is set to a specific time interval, usually between 0.5 and 1.0 seconds with current encoding technology, although a time interval exact to the frame is preferred. When queried, the web service returns the frame that most closely corresponds to the specified time. This web service is called using the following convention: vipdemo.immersivemedia.co./serveJpeg.php!force_file=1&scene=N3&time=0.5 where the “time” parameter is the number of seconds since playback started. When this web service is called, it results in the download of a JPEG image. When the video is paused, the time variable is appended to the end of the STILL WEB SERVICE URL request string (http://vipdemo.immersivemedia.com/serveJpeg.php?force_file=1&scene=N3&) that is specified in the Viewer's host HTML page. This initiates a download of the JPEG still. When this is finished, the current frame of streaming video is replaced by its high-resolution counterpart. Preferably the loading of the higher-resolution frames should not overwrite the equivalent lower resolution frames in the buffer, so that if a command is given to resume playback at the original frame rate and resolution, the image information will already be there to allow a smooth resumption of the original type of display.

To give further details of this example of the implementation, here is the anatomy of how the HTML interface is structured. The bold fields represent configurable entries, and all entries with the same name (WIDTH, HEIGHT, PREBUFFER TIME, etc) must have the same values in the HTML:

...

<object classid=“clsid:166B1BCA-3F9C-11CF-8075-444553540000”

codebase=“http://active.macromedia.com/director/cabs/sw.cab#version=6,0,

1,0” WIDTH= WIDTH HEIGHT= HEIGHT >

<param name=“SRC” value=“videoThumbnail.dcr”>
<param name=“sw2” value=“URL TO FLV STREAM ”,

WIDTH,HEIGHT,PREBUFFER TIME ,STILL WEB SERVICE URL”>

<param name=swRemote value=“swSaveEnabled=‘false’ swVolume=‘false’

swRestart=‘false’ swPausePlay=‘false’ swFastForward=‘false’
swContextMenu=‘false’ ”>

<embed src=“videoThumbnail.dcr” name=“Iditarod”

pluginspage=“http://www.macromedia.com/shockwave/download/”

type=“application/x-director”

width=“ WIDTH ” height=“ HEIGHT ”

swRemote=“swSaveEnabled=‘false’ swVolume=‘false’ swRestart=‘false’

swPausePlay=‘false’ swFastForward=‘false’ swContextMenu=‘false’ ” sw2=“ URL
TO FLV STREAM ”, WIDTH,HEGIHT,PREBUFFER TIME ,STILL WEB
SERVICE >
</embed>

. . .

If the “STILL WEB SERVICE URL” tag is left empty (“ ”) the viewer does not try to download a still when it is in the paused state.

### Operations, Ramifications and Scope

It will be appreciated by one skilled in the art that the present invention can also be presented in other embodiments. For example, the adjustment in resolution between the image server and the client viewer can take place over a local data communications network, such as image data stored on a local computer or being drawn from a storage medium such as a data disk or solid state storage device.

The variations in resolution according to bandwidth and frame rate can be implemented with a varying bandwidth connection, as long as there is a feedback reporting from the client to the image server to determine the available bandwidth and therefore the form of the content to be delivered.

The forms of the images to be delivered in this fashion is also variable according to the sensors or other means used for producing them. The images can be generated live from the image source, or be played back from some storage medium.

Although this technology has been particularly illustrated in the context of an immersive imaging system, it will be recognized that certain of these improvements likewise find applications in other contexts, e.g., single sensor imaging systems, and stereoscopic systems where multiple offset camera systems are used. Similarly, although image sensors operating in the visible light spectrum are contemplated, the same principles can likewise be applied for sensors operating at other wavelengths. In addition, computer graphics image generators can be used to generate the image frames, either wholly or in combination with photographic recordings.

Metadata such as image overlays can also be delivered as part of the image depending on the frame rate and available bandwidth. For example, commentaries, maps, and other graphic information about the image in view can be called upon and added to the delivered image feed if the bandwidth and the frame rate allow it. For example, an elaborate set of image overlays can be displayed over or as part of a still image freeze frame, whereas such overlays could be too confusing and be changing too rapidly for a moving picture.

It will be evident to artisans that features and details given above are exemplary only. Except where expressly indicated, it should be understood that none of the given details is essential; each is generally susceptible to variation, or omission.

1. A method for delivering images from a motion picture sequence at varying levels of image quality, comprising
storing in a memory of an image server computer plural copies of a sequence of images, each copy having a different level of image quality and representing plural frames of a motion picture sequence;
establishing communication over a computer network with an image client computer;
determining a first communication bandwidth available for transmission of the motion picture sequence from the image server computer to the image client computer;
transmitting a first copy of said sequence of images representing the frames of the motion picture sequence at a first frame rate and at a first level of image quality according to said first communication bandwidth;
receiving at the image server computer an indication from the image client computer of a specific frame of the motion picture sequence at which there is a specified change to a second frame rate; and
changing transmission of the motion picture sequence from the image server computer from the first level of image quality and first frame rate to a second level of image quality at the second frame rate.

2. The method of claim 1, wherein the request from the image client computer corresponds to a motion picture pause command at the image client computer and the second level of image quality corresponds to a maximum level of image quality for said specific frame.

3. The method of claim 1, wherein each of said plural copies of the sequence of images represents a different frame rate.

4. The method of claim 1, wherein at least one of said copies of the sequence of images is a sequence of JPEG still images.

5. The method of claim 1 wherein said image quality represents image resolution.

6. The method of claim 1 wherein said image quality represents an amount of data compression.

7. The method of claim 1 wherein said image quality represents a choice of codec.

8. The method of claim 1 wherein said client image computer includes a viewing application for image display and control of frame rate.

9. The method of claim 1, wherein said sequence of images represents a sequence of panoramic images.

10. A method for displaying images from a motion picture sequence at varying levels of image quality, comprising
establishing communication over a computer network with an image server computer with a memory having stored thereon plural copies of a sequence of images, each copy having a different level of image quality and representing plural frames of a motion picture sequence;
determining a first communication bandwidth available for transmission of the motion picture sequence from the image server computer to the image client computer;
requesting said sequence of images from the motion picture sequence;
receiving and displaying said sequence of images from the motion picture sequence from the image server computer at a first frame rate and at a first level of image quality, according to said first communication bandwidth;
transmitting to the server image computer an indication of a frame in the motion picture sequence at which there is a specified change to a second frame rate;
receiving at the client image computer at least one frame of a second level of image quality at the second frame rate, and
displaying said at least one frame at said second level of image quality and at said second frame rate.

11. The method of claim 10, wherein said specified change to the second frame rate corresponds to a motion picture pause command, and the second level of image quality corresponds to a maximum level of image quality.

12. The method of claim 10, wherein each of said plural copies of the sequence of images represents a different frame rate.

13. The method of claim 10, wherein at least one of said copies of the sequence of images is a sequence of JPEG still images.

14. The method of claim 10, wherein said image quality represents image resolution.

15. The method of claim 10, wherein said image quality represents an amount of data compression.

16. The method of claim 10, wherein said image quality represents a choice of codec.

17. The method of claim 10, wherein said sequence of images represents a sequence of panoramic images.

18. The method of claim 17, wherein displaying said sequence of images from the motion picture sequence includes displaying a region of interest within said panoramic images.

19. The method of claim 10, further including buffering at least some of the received image frames at a first level of image quality prior to their display, and wherein the image frames received at the second level of image quality do not overwrite the same image frames with the same frame numbers at a first level of image quality in said buffer.
